(19) United States
(12) Patent Application Publication
(10) Pub. No.: US 2013/0213242 A1
(43) Pub. Date: Aug. 22, 2013

(54) INFRARED CHARCOAL GRILL

(71) Applicant: EMPIRE COMFORT SYSTEMS, INC., (US)

(72) Inventor: Michael D. Shippy, Georgetown, KY (US)

(73) Assignee: EMPIRE COMFORT SYSTEMS, INC., Belleville, IL (US)

(21) Appl. No.: 13/746,676

(22) Filed: Jan. 22, 2013

Related U.S. Application Data
(60) Provisional application No. 61/600,385, filed on Feb. 17, 2012.

(51) Int. Cl. A47J 37/07

(52) U.S. Cl. CPC A47J 37/0786
USPC 99/445; 99/447

(57) ABSTRACT

A cooking apparatus comprising a housing defining an inner burn chamber, a charcoal tray in the burn chamber for holding charcoal; a cooking surface above the charcoal tray; and an infrared energy emitter positioned between the charcoal tray and the cooking surface. The cooking surface generally is a cooking grid or grill. The infrared energy emitter can be removable and comprise a ceramic, radiant glass or metal element positioned just below the cooking grid, wherein the energy emitter absorbs heat energy in the form of convection and infrared radiant heat generated by burning charcoal in the charcoal tray. The energy emitter generally reaches temperatures of about 200° to about 1000° F.

### CROSS REFERENCE TO RELATED APPLICATIONS

This application claims the benefit of provisional patent application Ser. No. 61/600,385, filed Feb. 17, 2012, which is incorporated herein by reference.

### FIELD OF THE INVENTION

The invention relates generally to apparatus for cooking foods with heat and more particularly to a barbeque grill that employs infrared heat to cook selected food items.

Cooking apparatus such as barbeque grills are known to the art. In most embodiments, the barbeque grill includes a body or housing for enclosing a heat source, such as gas burners or charcoal, and a grill positioned above the heat source. The food products, such as meat, vegetables, sea food or the like, are placed on the grill for cooking. The grill typically is a grid or lattice work structure that allows heat from the heat source to reach the food. Also, the grill allows juices, grease or fat to drip on the heat source.

In gas barbeque grills, gas burners are the heat sources that produce a flame. In charcoal barbeque grills, burning charcoal produces radiant heat and sometimes flame. In the former, the heat level is controlled by controlling gas flow to the burner. The level of heat is more difficult to control in charcoal barbeque grills. In either apparatus, it is difficult to prevent flames from scorching or burning the food, for example if grease or basting oils drip on the heat source and flames up.

Cooking apparatus that have a barrier between the food and a gas heat source are known. However, it would be advantageous to provide a cooking apparatus that accommodates charcoal as the heat source and includes an infrared energy emitter positioned between the charcoal and the food on the grill.

### SUMMARY OF THE INVENTION

Briefly stated, cooking apparatus comprising a housing that defines an inner cooking chamber, a charcoal tray in the burn chamber and a cooking surface above the charcoal tray. An infrared energy emitter is positioned between the charcoal tray and the cooking surface.

In one aspect, the cooking surface is a cooking grid or grill.

In one aspect, the infrared energy emitter is a radiant element such as a ceramic, glass or metal element positioned above the burn chamber and just below the cooking grids. The radiant element absorbs heat energy which is generated by the charcoal fuel source in the charcoal tray in the form of convection, and infrared radiant heat from the burning coals that is heated and transfers the heat and radiant energy to the food. The radiant element reaches temps of about 200° to about 1000° F. depending on air flow into the burn chamber which can be controlled by air flow adjustments.

In one illustrated embodiment, the radiant element is a radiant glass or ceramic element.

The housing includes a lid and is sealed; air controls allow for the total control of cooking temperatures between about 200° and about 800° F. with the lid closed.

In another aspect, the radiant element acts as a diffuser between the charcoal and food.

In another aspect, the radiant element provides a hot surface for juices and drippings to fall on and vaporize back up through to the food to give the food moisture and flavor.

Infrared radiant cooking cooks from the outside inward which sears the food surface first locking in the juices and then continuing to cook through to the center.

In another aspect, the radiant element is removable for cleaning and for use of the cooking apparatus as a conventional charcoal grill.

In one aspect the radiant element is a radiant glass or ceramic element is thermo shock resistant and will not crack as a result of water or liquids contacting the hot surface.

### BRIEF DESCRIPTION OF THE DRAWINGS

FIG. 1 is a front perspective view of the infrared charcoal grill of the present invention;

FIG. 2 is top perspective view of the radiant glass element and cooking grids;

FIG. 3 is a top perspective view of the charcoal tray;

FIG. 4 is a partial, perspective view of the removable ash pan;

FIG. 5 is a partial front view showing the charcoal access door in an open position; and

FIG. 6 top perspective view showing a ceramic radiant glass element in two sections.

### DETAILED DESCRIPTION

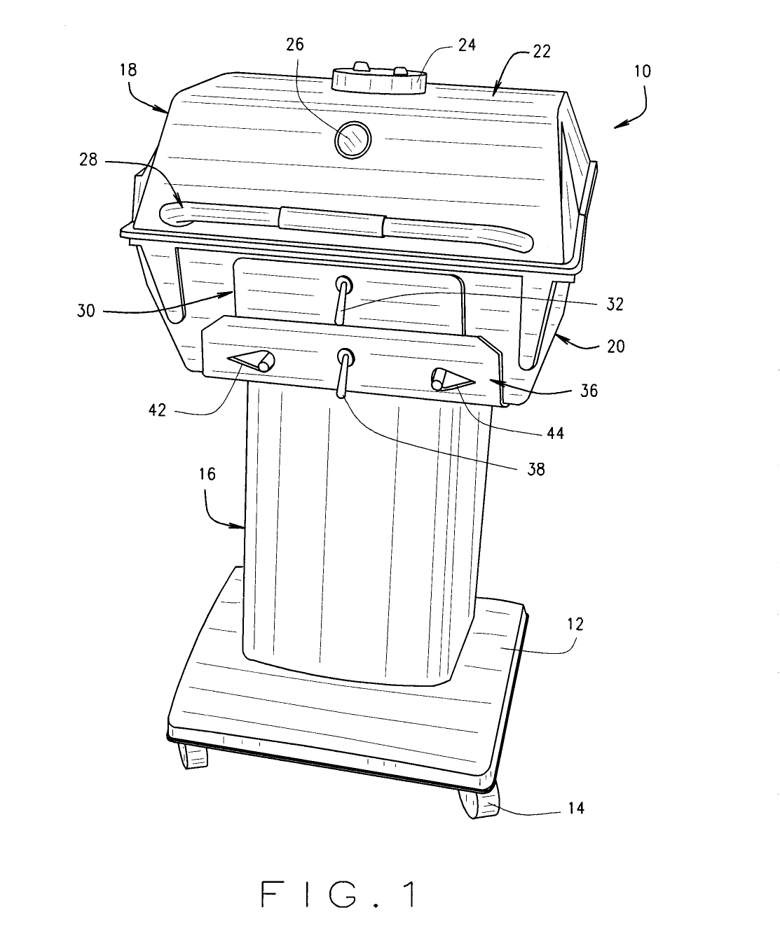

The infrared charcoal grill of the present invention is indicated by reference number 10 in FIG. 1. Grill 10, which may be referred to as a barbecue grill, outdoor cooker, or any other descriptive name, comprises a base 12 for resting on a surface. The base can include casters or wheels 14 for ease of movement.

There is a pedestal 16 on the base and the main grill body 18 at the top of the pedestal. Although this arrangement of grill body, pedestal and base is one preferred embodiment of grill 10, it is intended to be illustrative. Grill 10 can have any overall configuration and components. For example it could have multiple legs and no pedestal or base; it could have short legs for a table top version. The number of elements or arrangement is limitless.

In any event, as show, body 18 comprises a box-like housing having a bottom section 20 and a lid 22. The bottom section and lid each define inner chambers which together define a firebox/cooking chamber 23. In one embodiment the body is constructed from heavy cast aluminum. Lid 22 includes a top vent 24 for controlling airflow and heat, a thermometer 26 that is in functional communication with the interior of body, and a handle 28. Again the configuration and arrangement of these elements can vary. It will be noted that lid 22 can be attached to the bottom section by a hinge engages the perimeter of bottom section 20 in an airtight fit provided by seals.

Bottom section 20 defines an opening 29 (FIG. 5) and includes an upper fuel access door 30 having a locking handle 32 and a peripheral seal 34. There is a lower ash removal door 36 with a locking handle 38. Lower door 36 has interior peripheral seal 39 mesh liner 40 and a pair of sliding vents 42, 44 that can be opened and closed to control airflow and heat within the cooking chamber.

As seen in FIGS. 3 and 5, there is fuel tray 46 within the bottom section and accessible from the top or through fuel access door 30. Tray 46 has a plurality of openings 47 therein to allow airflow to the fuel, which generally is lump hardwood charcoal or charcoal briquettes. The fuel tray can be stainless steel or cast iron, such as porcelain coated cast iron. Tray 46 can include handles 48 to support the radiant element described below and for removal for emptying and cleaning.

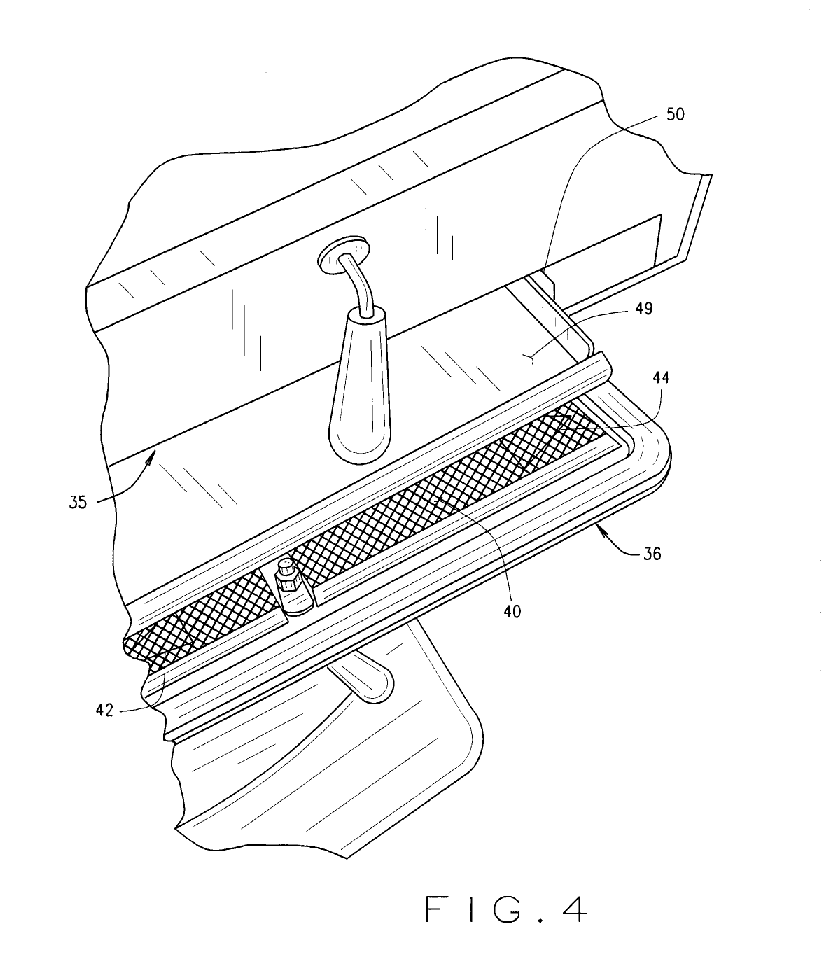

As seen in FIG. 4, the grill includes a removable ash pan 49 slidingly engaged in tracks 50. Ash pan 49 is positioned below fuel tray 46 and accessible through lower ash removal door.

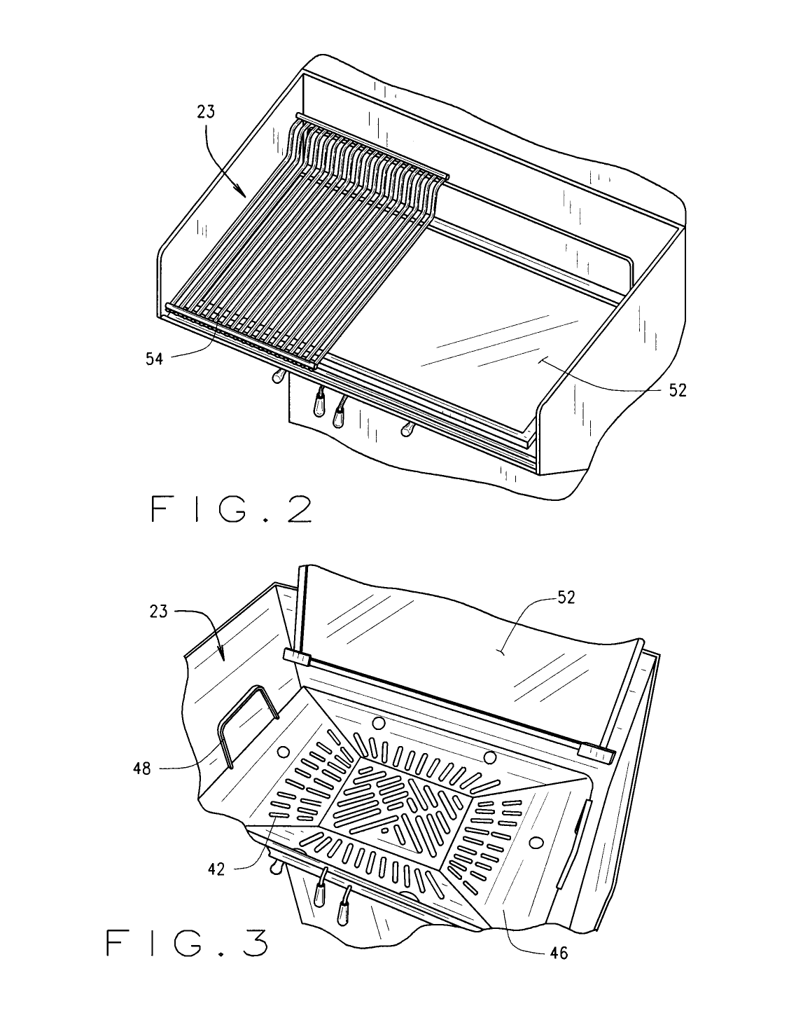

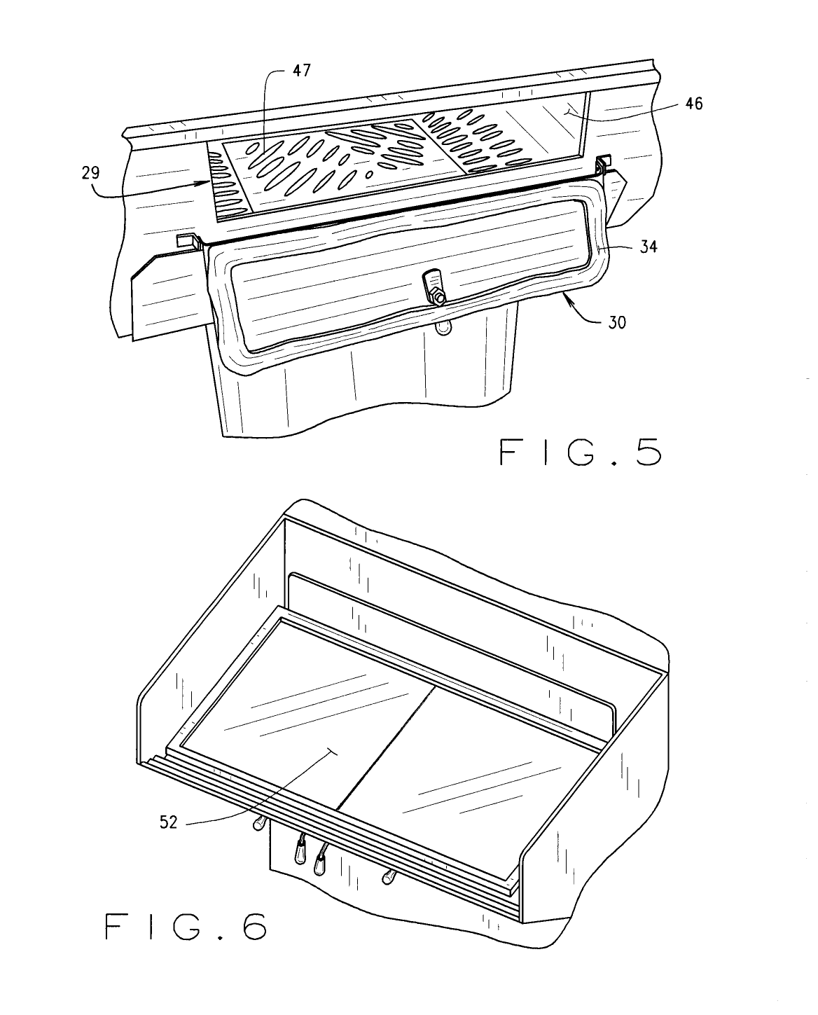

As best seen in FIGS. 2 and 6, there is a radiant element 52 positioned above fuel tray 46. FIG. 2 shows radiant element as a single element. As shown in FIG. 6, radiant element 52 can be divided into multiple sections. Although shown having two sections, it will be understood that more than two sections would be acceptable. In the illustrated embodiment, radiant element is a ceramic glass or ceramic radiant element. However, element 52 can be any appropriate material, such as ceramic, glass, metal, coated metal or combinations thereof. Element 52 can be removable or can be attached to the bottom section by hinges or the like so that it could fold up out of the way, if desired. There are cooking grids 54 positioned above radiant element 52. Generally cooking grids 54 are formed from stainless steel or other appropriate material. Food products for cooking are placed on grids 54 as commonly understood.

Radiant element 52 is positioned above the fuel and is just below cooking grids 54. Element 52 absorbs the heat energy which is generated by the charcoal fuel source in the form of convection, and infrared radiant heat from the burning coals which will heat radiant element 52 and transfer the heat and radiant energy to the food.

Element 52 optimally reaches temps of about 200° F. to about 1000° F. depending on the controlled air flow adjustments of vents 24, 42 and 44. Element 52 also acts as a diffuser between the charcoal and food which also provides a hot surface for juices and drippings to fall on and vaporize back up through to the food giving the food moisture and flavor which generally does not happen with direct charcoal grilling.

Element 52 is easily removed for cleaning and conventional charcoal grilling. Element 52 can be provided with the grill, or can be provided as an accessory to the grill. Ceramic or glass elements are thermo shock resistant and will not crack do to water or liquids contacting the hot surface. The sealed grill housing and air controls allow for the total control of oven temps between 200° F. and 800° F. with lid 22 closed. Infrared radiant cooking will cook foods from the outside inward which sears the food surface first locking in the juices and then continuing to cook through to the center.

1. A cooking apparatus comprising,
a housing defining an inner burn chamber;
a charcoal tray in the burn chamber for holding charcoal;
a cooking surface above the charcoal tray; and
an infrared energy emitter positioned between the charcoal tray and the cooking surface.

2. The cooking apparatus of claim 1 wherein the cooking surface is a cooking grid.

3. The cooking apparatus of claim 1 wherein the infrared energy emitter is a radiant element positioned just below the cooking grid, wherein the radiant element absorbs heat energy generated by burning charcoal in the charcoal tray.

4. The cooking apparatus of claim 1 wherein the infrared energy emitter comprises one or more of ceramic, glass, metal and coated metal.

5. The cooking apparatus of claim 1 wherein the infrared energy emitter comprises more than one section.

6. The cooking apparatus of claim 4 wherein the infrared energy emitter is radiant glass element.

7. The cooking apparatus of claim 3 wherein the heat energy is in the form of convection and infrared radiant heat.

8. The cooking apparatus of claim 6 wherein the radiant glass element reaches temperatures of about 200° to about 1000° F.

9. The cooking apparatus of claim 1 wherein the housing comprises a lid.

10. The cooking apparatus of claim 9 wherein the housing and lid are sealed when the housing and lid are in a closed relationship.

11. The cooking apparatus of claim 10 further comprising air flow controls for the control of cooking temperatures within the housing.

12. The cooking apparatus of claim 10 wherein the cooking temperatures within the housing are between about 200° and 800° F. with the lid in a closed position.

13. The cooking apparatus an infrared energy emitter of claim 1 wherein the infrared energy emitter is removable.

14. The cooking apparatus of claim 6 wherein radiant glass element is thermo-shock resistant and will not crack as a result of water or liquids contacting the hot surface.

15. A grill comprising,
a housing defining an inner burn chamber;
a charcoal tray in the burn chamber for holding charcoal;
a cooking surface above the charcoal tray; and
an infrared energy emitting radiant glass element positioned between the charcoal tray and the cooking surface;
a lid on the housing to close the inner burn chamber.

16. The grill of claim 15 wherein the infrared energy emitting glass element is removable.

17. The grill of claim 15 wherein the infrared energy emitting glass element comprises more than one section.

18. A barbeque grill comprising,
a housing defining an inner burn chamber;
a charcoal tray in the burn chamber for holding charcoal;
a cooking surface above the charcoal tray; and
means for producing infrared energy between the charcoal tray and the cooking surface.
